(19) United States
(12) Patent Application Publication
(10) Pub. No.: US 2005/0285355 A1
(43) Pub. Date: Dec. 29, 2005

(54) Quick removable chuck assembly and its cutting tool

(76) Inventor: Yuan-Ho Lin, Ta Li City (TW)

Correspondence Address: CHARLES E. BAXLEY, ESQ., 90 JOHN STREET, THIRD FLOOR, NEW YORK, NY, 10038, US

(21) Appl. No.: 10/876,896

(22) Filed: Jun. 24, 2004

(51) Int. Cl. B23B 31/171

(52) U.S. Cl. 279/81

(57) ABSTRACT

The present invention discloses a quick removable chuck assembly and its cutting tool comprises a cutting tool with its positioning section passing through an axial hole of a main body; a sliding device being disposed on a wall of the main body and capable of moving back and forth horizontally along the axis of the main body; a device embedding groove being disposed at a positioning section of the cutting tool for embedding the sliding device; and a positioning sleeve being axially disposed outside the main body for controlling the sliding device to move back and forth by a rotary action; thereby the present invention can achieve the objectives of installing and removing the cutting tool in a quick and convenient manner.

### BACKGROUND OF THE INVENTION

1. Field of the Invention

The present invention relates to a chuck, more particularly to a chuck that allows users to rotate and control a lower positioning sleeve of the chuck, so that the chuck can install or remove a drilling tool (such as a drill head).

2. Description of the Related Art

In general, a chuck assembly of a traditional drilling tool (such as a drill head) usually connects a main body with a power axle of a transmission device, and the main body comprises a plurality of aslant guided holes on the walls of the main body, a clamper disposed in each aslant guided hole, and the clamper is controlled by a driving ring coaxially disposed outside the main body. In other words, a synchronous aslant movement can be produced along an axis not parallel to the main body by rotating the driving ring, so that when a plurality of clampers move slantwise towards the axial direction of the main body, a cutting tool is clamped. Conversely, the cutting tool is released.

The aslant guided hole on the main body relates to the inclination of the clamper with the main body, the moving direction of the clamper and the force of clamping the cutting tool. Therefore, the structure of the aslant guided hole and the clamper requires a high precision which will relatively increase the manufacturing cost. If the cutting tool encounters a larger resistance in its operation, the clamper and the cutting tool probably will be stripped, which indicates an insufficient clamping force provided by the clamper. Therefore, many designs for improving the torque of the clamper chuck are introduced, but most of these designs come with a very complicated structure and have a very high manufacturing cost.

### SUMMARY OF THE INVENTION

The primary objective of the present invention is to overcome the shortcomings of the prior-art clamper chuck structure carrying a high manufacturing cost and having insufficient clamping force. The present invention intends to use a solution totally different from the prior art to overcome the foregoing shortcomings and achieve the objectives of simplifying the structure of the chuck, making the assembling and positioning of the cutting tool convenient and quick, providing a precise positioning in the axial direction and the direction of the rotation of the cutting tool, and improving the stability of installing the chuck onto the cutting tool. More particularly, the positioning along the direction of the rotation can effectively prevent the stripping and idle operation of the cutting tool, and thus improving the torque of the cutting tool. In addition, the present invention controls the installation and removal of the cutting tool by rotating a positioning sleeve; after the positioning sleeve is rotated to an appropriate angle, the present invention also provides a solution for limiting the angle of rotation appropriately instead of freely rotating in 360 degrees. Such arrangement assures the positioning of the related objects and prevent any damage caused by an over rotation.

The technical measures taken by the present invention for solving the foregoing problems comprises:
a main body, having an axial hole at its center, a cutting tool receiving hole disposed at a lower section of the axial hole, a device receiving hole disposed on a wall of the cutting tool receiving hole, and a sliding device disposed in the device receiving hole;
a lower positioning sleeve, having an axial hole at its center that sheathes onto the lower section of the main body, at least a recessed space disposed on an internal wall of the axle hole along a radial direction and a pushing surface being extended aslant along a wall of the axle hole in the recessed space, such that the recessed space and the push surface being corresponsive to the sliding device;
a cutting tool, having a positioning section at an end other than its working end, and the positioning section passing through the cutting tool receiving hole along the axial direction of the main body and having at least one device embedding groove disposed on the surface of the positioning section for latching the sliding device;
   an upper positioning sleeve, having an axle hole at its center for fixing the upper positioning sleeve outside an upper section of the main body;
a spring, being coupled onto the exterior of the main body and disposed between the upper and lower positioning sleeves; and
a positioning device disposed on a wall of the cutting tool receiving hole along its radial direction, and one end of the positioning device is protruded from the cutting tool receiving hole, and the cutting tool at its positioning section has at least one channel for embedding an end section of said positioning device, and the other end of the positioning device is protruded from an external wall of the main body, and a limit groove is disposed on part of the periphery of a wall of the hole at the lower section of the positioning sleeve for accommodating an end section of the positioning device.

### BRIEF DESCRIPTION OF THE DRAWINGS

FIG. 1 is a top view of the disassembled parts of the chuck assembly according to a preferred embodiment of the present invention.

FIG. 2 is a bottom view of the disassembled parts of the chuck assembly according to a preferred embodiment of the present invention.

FIG. 3 is a bottom view of the disassembled parts of the lower positioning sleeve according to a preferred embodiment of the present invention.

FIG. 4 is a perspective view of the chuck assembly according to a first preferred embodiment of the present invention.

FIG. 5 is a cross-sectional view of Section 5-5 of FIG. 4.

FIG. 6A is a cross-sectional view of Section 6A-6A of FIG. 4.

FIG. 6B is an illustrative view of the movements as depicted in FIG. 6A.

FIG. 7A is a cross-sectional view of Section 7A-7A of FIG. 6A.

FIG. 7B is a cross-sectional view of Section 7B-7B of FIG. 6B.

FIG. 8 is a cross-sectional view of a second preferred embodiment of the present invention.

FIG. 9 is: a cross-sectional view of a third preferred embodiment of the present invention.

FIG. 10 is an exploded view of the chuck according to a fourth preferred embodiment of the present invention.

FIG. 11 is an exploded view of the chuck according to a fifth preferred embodiment of the present invention.

FIG. 12 is an exploded view of the chuck according to a sixth preferred embodiment of the present invention.

### DETAILED DESCRIPTION OF THE PREFERRED EMBODIMENTS

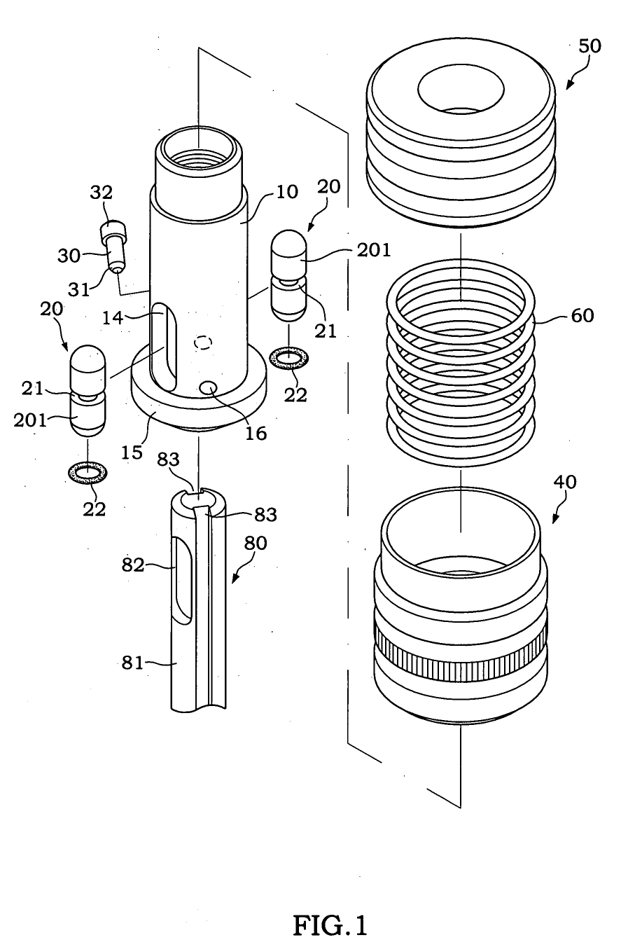

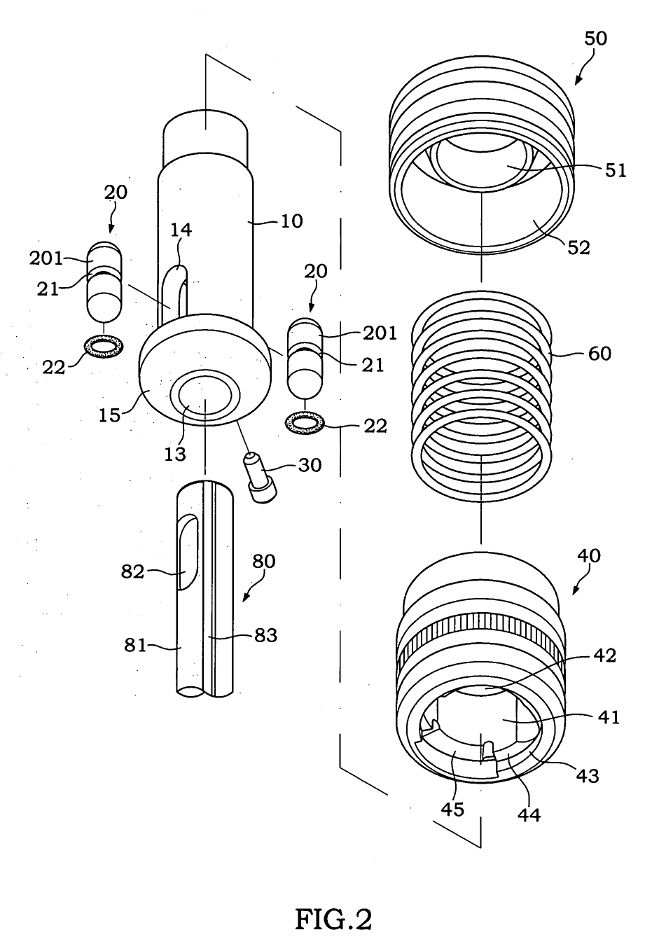

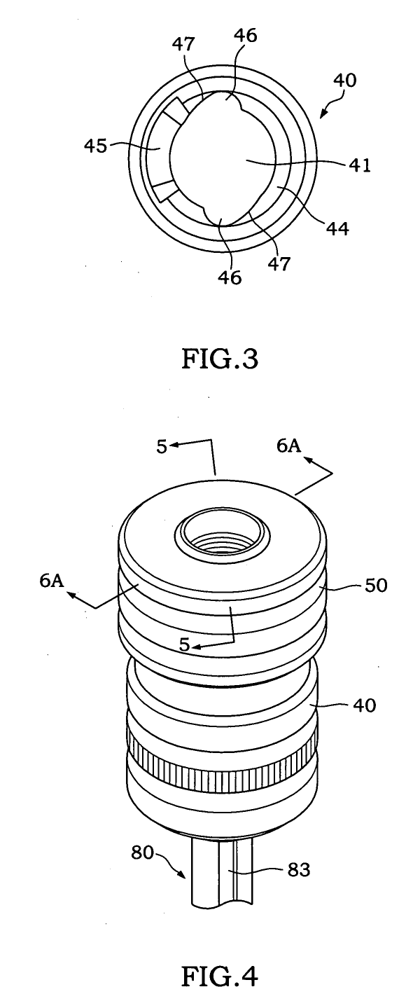

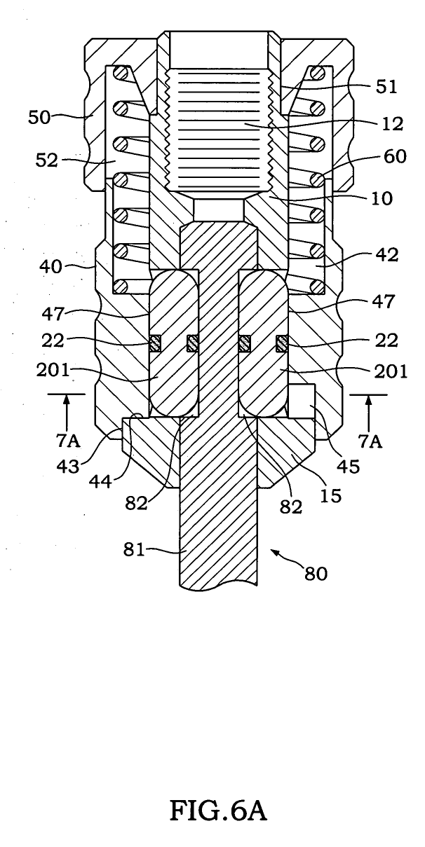

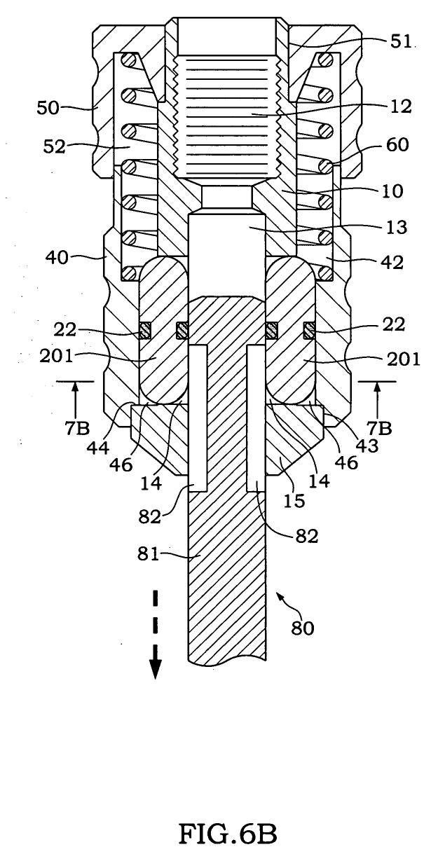

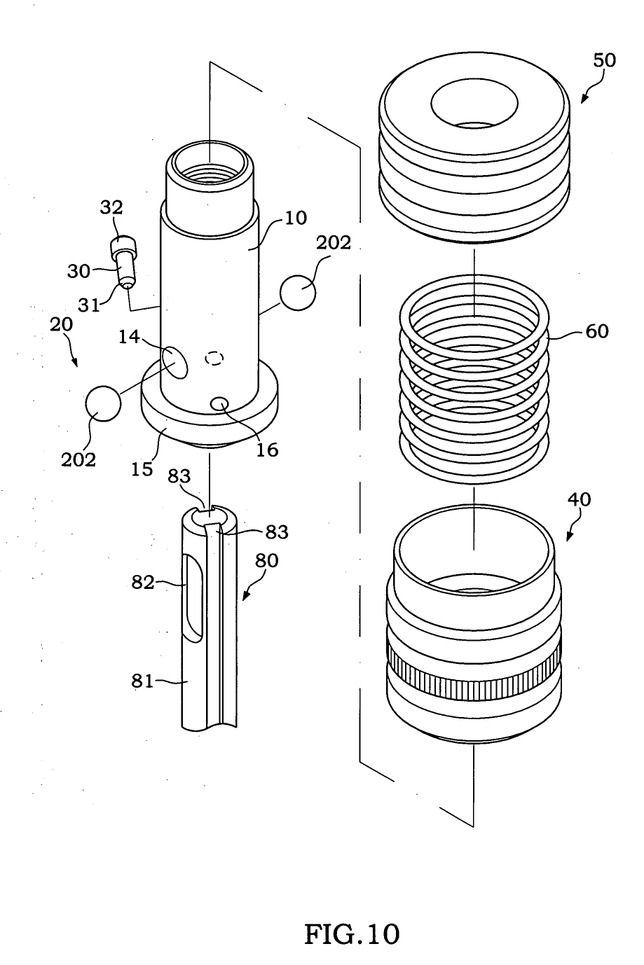

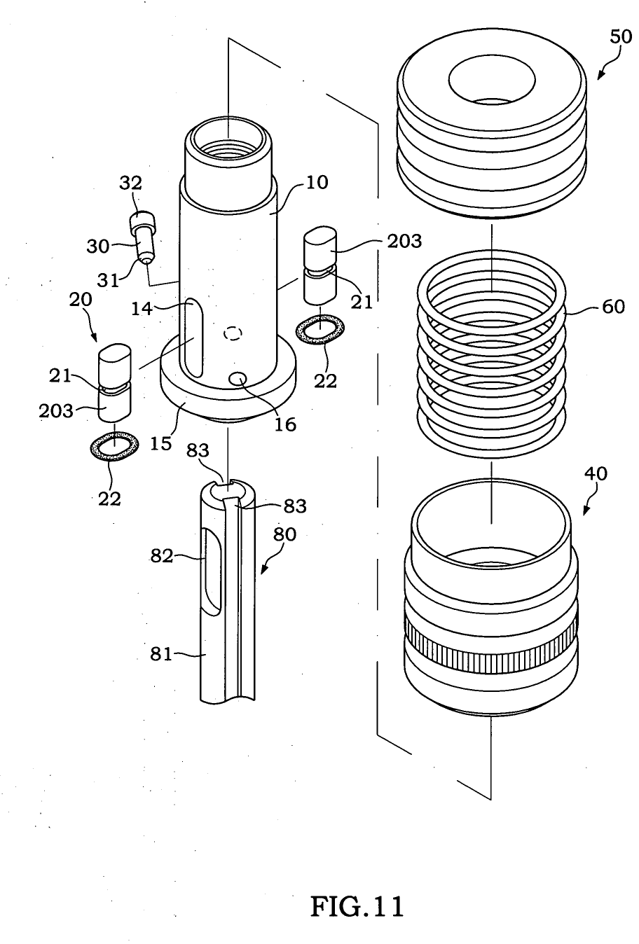

The present invention relates to a quick removable chuck assembly, comprising:
a main body 10 as shown in FIGS. 1, 2, 5 and 6, with an axial hole passing through its center, and the axle hole can be divided into an upper section and a lower section, wherein the upper section is a power axle hole 12 for connecting a power axle of a transmission device (not shown in the figures) and the lower section is cutting tool receiving hole 13 for passing a cutting tool 80 (such as a drill head) through a positioning section 81 disposed at an end other than the operating end, and the main body 10 has a stop member 15 with an expanded diameter;
a positioning assembly as shown in FIGS. 1, 2 and 6A, having a device hole disposed at a corresponding position on the wall of the cutting tool receiving hole 13, and a sliding device 20 disposed in each device hole, and the sliding device 20 could be a rolling needle 201 as shown in FIG. 1 or a rolling ball 202 as shown in FIG. 10 or a sliding member 203 as shown in FIG. 11, and the device hole 14 can appropriately block the sliding device 20 protruded from the cutting tool receiving hole 13 by the internal side of the hole of the device hole 14 to prevent the sliding member 23 from falling out; two device embedding grooves 82 are disposed at the corresponding positions on the surface of the positioning section 81 of the cutting tool 80, such that the positioning section 81 passes into the cutting tool receiving hole 13, and part of the periphery of the sliding device 20 is latched into the device embedding groove 82 to fix the cutting tool 80 in the axial direction and the direction of the rotation; the sliding device 20 at its center comprises an external circular groove 21 and a washer 22 is disposed in the external circular groove 21, such that when the sliding device 20 is latched into the device embedding groove 82, the washer 22 fills the gap to prevent the sliding device 20 from shaking;
a cutting tool positioning reinforcing structure as shown in FIGS. 1, 2 and 5, having at least one through hole 16 along the axial direction of the wall on the main body corresponding to the cutting tool receiving hole 13, and a positioning device 30 is disposed in the through hole 16 with its internal end 31 protruded inwardly into the cutting tool receiving hole 13 and its external end 32 protruded outwardly from the through hole 16; a channel 83 is disposed in the axial direction on the wall of the positioning section 81 of the cutting tool 80 and defines an opening at the open end of the positioning section of the channel 83 to pass the internal end of the positioning device 30 when the positioning section 81 passes through the cutting tool receiving hole 13 to reinforce the positioning of the rotation of the main body 10 and the cutting tool 80;
an upper positioning sleeve 40 as shown in FIGS. 1, 2, 3 and 5, having an axle hole 41 and the upper half of the axle hole 41 with an expanded diameter defines a spring accommodating section 42 and forms an expanded accommodating groove 43 and a stop position 44 at an end other than the spring accommodating section 42 and further builds an arc limit groove 45 recessively disposed along the axial direction and on part of the periphery of the stop position 44; two recessed spaces 46 are disposed along the radial direction at the corresponding positions on the wall of the axle hole 41 and a pushing surface 47 is extended slantwise form the internal wall of the axle hole 41 along one side of the space 46; the main body 10 goes through the axle hole 41; the accommodating groove 43 accommodates a section of the stop member 15, and stop each other by the stop position 44 and the stop member 15; wherein the two sliding devices 20 correspond with the space 46 and the push surface 47, and the external end 32 of the positioning device 30 is disposed in the limit groove 45;
an upper positioning sleeve 50 as shown in FIGS. 1, 2 and 5, being a hollow sheath and having an axle hole 51 with the interior of its wall extended to a predetermined distance for closely coupling the top end of the main body 10 into the axle hole 51; a spring accommodating section 52 is reserved between the axle hole 51 and the internal wall of the upper positioning sleeve 50; and
a spring 60 as shown in FIGS. 1, 2 and 5, being coupled onto the exterior of the main body 10 and disposed in the spring accommodating section 52, 42 between the upper and lower positioning sleeves 50, 40.

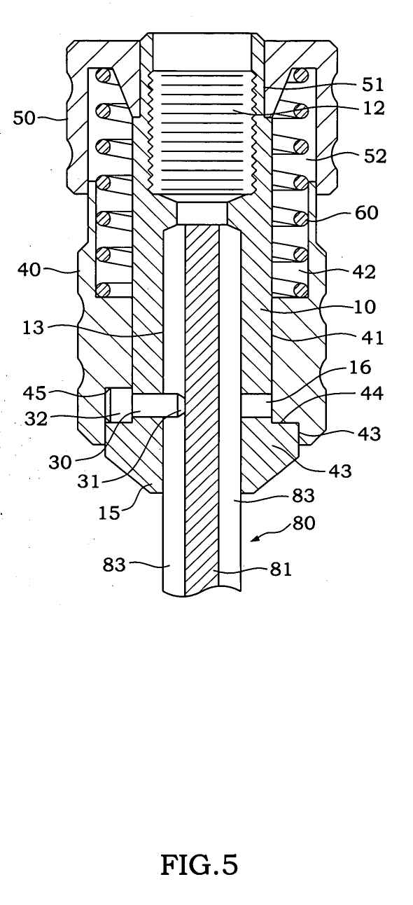

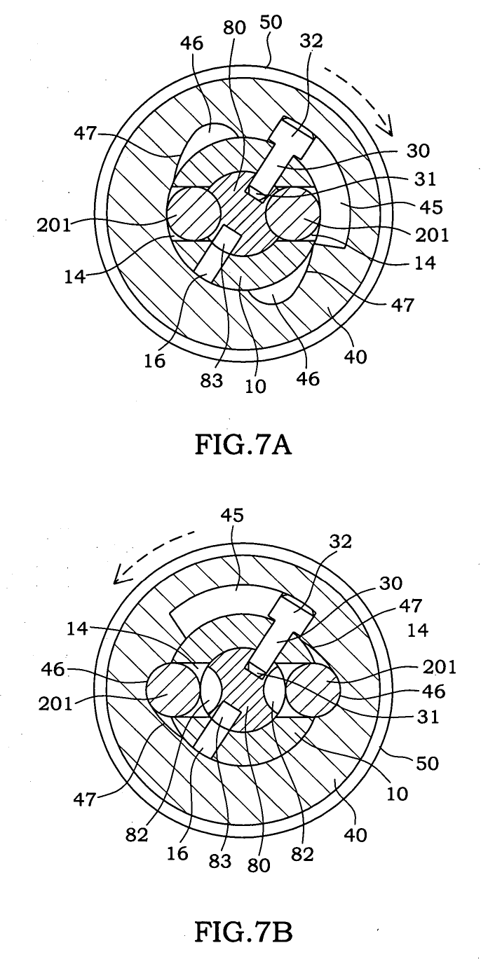

The lower positioning sleeve 40 as shown in FIGS. 5 to 7B is a device provided for a user to hold and rotate to move the sliding device 20 between the space 46 and the push surface 47 or move the sliding device 20 from the external end of the positioning device 30 into the limit groove 45.

If the cutting tool 80 is installed in or removed from the corresponding space 46 of the sliding device 20, the positioning section 81 will push the sliding device 20 towards the direction away from the axle of the main body 10 into the space 46. Therefore, the positioning section 81 of the cutting tool 80 can move freely in and out of the cutting tool receiving hole 13. If the positioning section 81 is located in the cutting tool receiving hole 13 and the lower positioning sleeve 40 is rotated, the guide provided by the push surface 47 will push the sliding device 20 towards the axial direction of the main body 10 to latch the sliding device 20 into the device embedding groove 82 of the cutting tool 80, and the cutting tool is fixed in the axial direction. In the meantime, the internal end 31 of the positioning device 30 is stopped in the channel 83, and thus the cutting tool 80 can be limited in the direction of the rotation and the main body 10 can drive the cutting tool 80 to rotate. Even if the cutting tool encounters a larger resistance during its operation, the cutting tool 80 will not run in idle and thus improving the torque of the cutting tool.

If the lower positioning sleeve 40 is rotated, the positioning device 30 and the limit groove 45 of the lower positioning sleeve 40 provide the best solution for the angle of rotation. In other words, when the sliding device 20 corresponds to the space 46 or the terminal of the push surface 47, the external end 32 of the positioning device 30 will be located at one end of the limit groove 45 and blocked by the wall of the groove, so that the lower positioning sleeve 40 cannot be rotated further in the same direction, and the operator can know that the cutting tool 8 has been installed into a fixed position or can be removed. In addition, the arrangement of the limit groove 45 and the external end 32 of the positioning device 30 can also prevent the chuck from being rotated to secure with the main body 10 and the lower positioning sleeve 40 too tight as the operation goes on and also prevent the situation that the cutting tool cannot be removed manually after the operation is completed.

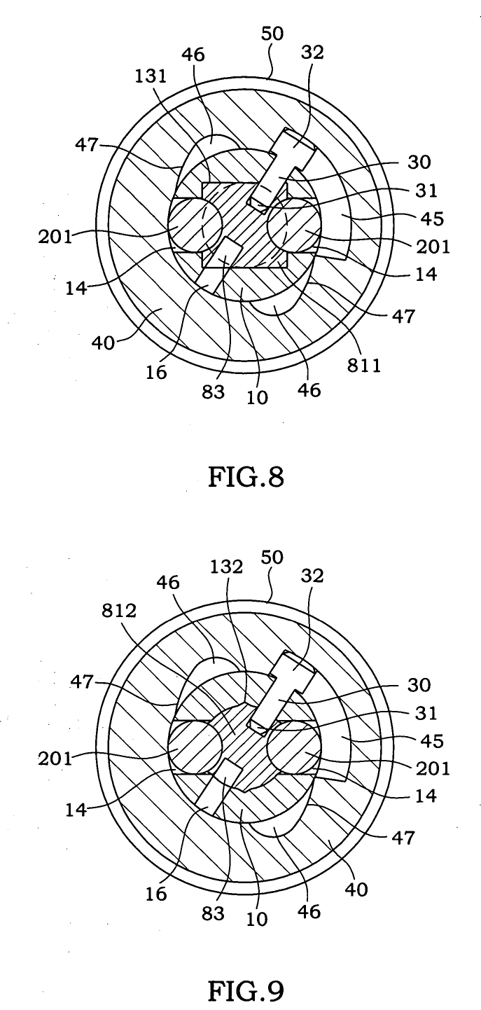

In FIGS. 8 and 9, the positioning section 81 of the cutting tool 80 and the cutting tool receiving hole 13 have a circular cross section. Of course, the positioning section 81 could be a polygonal cylinder 811, 812 such as a hexagonal cylinder or a rectangular cylinder, and the cross-section of the cutting tool receiving hole 131, 132 should be in the corresponding shape. With the connection by a polygonal cylinder, the same function for rotating and fixing a cutting tool can be achieved. In the figure, the circle indicated by doted lines refers to a cutting tool receiving hole 131, 132 in the shape of a hexagon or a square or any other shape corresponding to the cylindrical positioning section 81.

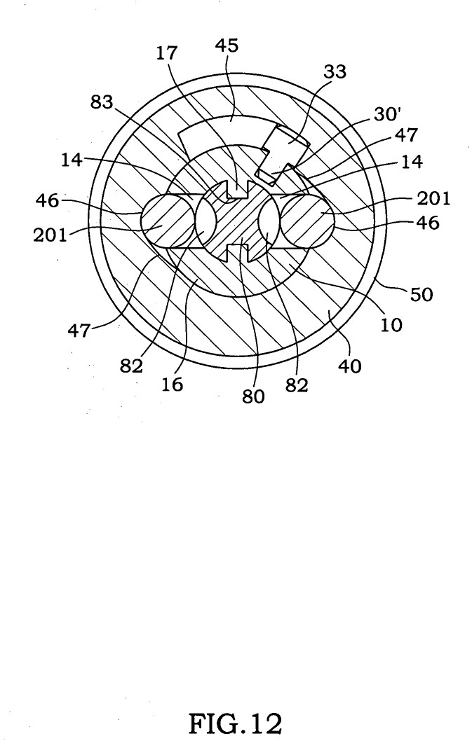

Please refer to FIG. 12 for another preferred embodiment of the present invention. The main body 10 comprises two embedded bars 17 protruded from the axial direction of the internal wall of the main body 10, and the embedded bar 17 can be embedded into the channel 83 of the cutting tool 80 to provide the rotating and positioning functions for the main body 10 and the cutting tool 80. To match up the disposition of the embedded bar 17, the original position of the positioning device can be changed slightly. In other words, the positioning device 30′ only has the external end 33 protruded from the main body 10 in the radial direction, but it does not have the internal end protruded from the power axle hole 12. Therefore, this embodiment still adopts the design of the external end 33 of the positioning device 30′ together with the limit groove 45 of the lower positioning sleeve 4 to control the angle of rotating the lower positioning sleeve 40.

In summation of the description above, the present invention overcomes the shortcomings of the prior-art and enhances the performance than the conventional structure and further complies with the patent application requirements and is submitted to the Patent and Trademark Office for review and granting of the commensurate patent rights.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements.

1. A quick removable chuck assembly, comprising:
a main body, having an axial hole at its center, a cutting tool receiving hole disposed at a lower section of said axial hole, a device receiving hole disposed on a wall of said cutting tool receiving hole, and a sliding device disposed in said device receiving hole;
a lower positioning sleeve, having an axial hole at its center that sheathes onto the lower section of said main body, at least a recessed space disposed on an internal wall of said axle hole along a radial direction and a pushing surface being extended aslant along a wall of said axle hole in said recessed space, such that said recessed space and said push surface being corresponsive to said sliding device;
a cutting tool, having a positioning section at an end other than its working end, and said positioning section passing through said cutting tool receiving hole along the axial direction of said main body and having at least one device embedding groove disposed on the surface of said positioning section for latching said sliding device;
an upper positioning sleeve, having an axle hole at its center for fixing said upper positioning sleeve outside an upper section of said main body; and
a spring, being coupled onto the exterior of said main body and disposed between said upper and lower positioning sleeves.

2. The quick removable chuck assembly of claim 1 further comprising a positioning device disposed on a wall of said cutting tool receiving hole along its radial direction, and one end of said positioning device being protruded from said cutting tool receiving hole, and said cutting tool at its positioning section has at least one channel for embedding an end section of said positioning device.

3. The quick removable chuck assembly of claim 1 further comprising a positioning device disposed on a wall of said cutting tool receiving hole along its radial direction, and one end of said positioning device being protruded from an external wall of said main body, and a limit groove being disposed on part of the periphery of a wall of said hole at the lower section of said positioning sleeve for accommodating an end section of said positioning device.

4. The quick removable chuck assembly of claim 1 further comprising a positioning device disposed on a wall of said cutting tool receiving hole along its radial direction, and an internal end of said positioning device being protruded from said cutting tool receiving hole and an external end of said positioning device being protruded from an external wall of said main body, and said cutting tool at its positioning section has at least one channel for embedding an internal end of said positioning device therein, and a limit groove being disposed on part of the periphery of a wall of said hole at the lower section of said positioning sleeve for accommodating an end section of said positioning device.

5. The quick removable chuck assembly of claim 1 further comprising a positioning device disposed on a wall of said main body along its radial direction, and an external end of said positioning device being protruded from said main body along its axial direction, and a limit groove being disposed on part of the periphery of a wall of said hole at the lower section of said positioning sleeve for accommodating an end section of said positioning device, and said main body comprises at least one embedding bar protruded from at an internal wall of said main body; and said positioning section of said cutting tool comprises at least one channel for latching said embedding bar.

6. The quick removable chuck assembly of claim 1, wherein said sliding device is a rolling needle.

7. The quick removable chuck assembly of claim 1, wherein said sliding device comprises an external circular groove disposed at its body section and a washer disposed in said external circular groove.

8. The quick removable chuck assembly of claim 1, wherein said sliding device is a rolling ball.

9. The quick removable chuck assembly of claim 1, wherein said sliding device is a sliding member.

10. The quick removable chuck assembly of claim 9, wherein said sliding device comprises an external circular groove disposed at its body section and a washer disposed in said external circular groove.

11. The quick removable chuck assembly of claim 1, wherein said positioning section of said cutting tool is a polygonal cylinder and said cutting tool receiving hole has a corresponding cross section.

12. The quick removable chuck assembly of claim 11, wherein said positioning section of said cutting tool is a hexagonal cylinder.

13. The quick removable chuck assembly of claim 11, wherein said positioning section of said cutting tool is a rectangular cylinder.

14. The quick removable chuck assembly of claim 1, wherein said cutting tool receiving hole has a cross section in the shape of a polygonal hole.

15. The quick removable chuck assembly of claim 14, wherein said positioning section of said cutting tool is a circular cylinder.

16. A cutting tool of quick removable chuck assembly, having a positioning section disposed at part of the section other than its operating end, and said positioning section comprising:
at least one device embedding groove, recessively disposed on a wall of said positioning section; and
at least one channel, being recessively disposed on a wall of said positioning section and defining an opening at an open end of said positioning section.

17. The cutting tool of quick removable chuck assembly of claim 16, wherein said positioning section of said cutting tool is a polygonal cylinder.

18. The cutting tool of quick removable chuck assembly of claim 16, wherein said positioning section of said cutting tool is a hexagonal cylinder.

19. The cutting tool of quick removable chuck assembly of claim 16, wherein said positioning section of said cutting tool is a rectangular cylinder.
